(19) United States
(12) Patent Application Publication
(10) Pub. No.: US 2008/0279374 A1
(43) Pub. Date: Nov. 13, 2008

(54) Pixel-Based Method for Encryption and Decryption of Data

(75) Inventors: Gy-Young Beak, Daejeon (KR); Kwon-Woo Hong, Daejeon (KR); Sang-Kyo Kim, Daejeon (KR)

Correspondence Address: THE RAFFERTY PATENT LAW FIRM, 5641 BURKE CENTRE PKWY, SUITE 100, BURKE, VA, 22015-2259, US

(73) Assignee: Gy Young BEAK, Daejeon (KR)

(21) Appl. No.: 12/064,027

(22) PCT Filed: Aug. 16, 2006
(86) PCT No.: PCT/KR2006/003201

§ 371 Date: Feb. 15, 2008

(30) Foreign Application Priority Data
Aug. 17, 2005 (KR) 10-2005-0075399

(51) Int. Cl. H04L 9/06

(52) U.S. Cl. 380/54

(57) ABSTRACT

A method for encrypting and decrypting data prevents counterfeiting or forgery of various on-line or off-line prints. A graphical image or text to be encrypted is fragmented into minute pixels as basic units. In connection with a shadow, a color, and a size of the fragmented pixels, a pixel having a predetermined characteristic value is defined as a reference pixel, and then non-reference pixels having different characteristic values with respect to the reference pixel are defined. A predetermined data value is allotted to each of the non-reference pixels, and the fragmented reference pixels are one-to-one substituted by the non-reference pixels. Thereby, desired information data can be inserted without changing the state of an original file to be encrypted.

### CROSS-REFERENCES TO RELATED APPLICATIONS

This is a US National Stage under 35 USC § 371 of International Application PCT/KR2006/003201, filed Aug. 16, 2006, and claims the benefit of priority of Republic of Korea Patent Application No. 10-2005-0075399, filed with the Korean Intellectual Property Office on Aug. 17, 2005, and registered as Republic of Korea Patent No. 10-0697879 on Mar. 14, 2007. Both the above-referenced International Application and the Republic of Korea Patent Application are incorporated by reference herein in their entireties.

### INTRODUCTION

The present discussion relates to a method for encrypting and decrypting data using pixels, in which data to be encrypted (such as characters, digits, figures, lines, pictures, etc.) is fragmented into minute pixels as basic units, and pixels that have a characteristic value different from that of a reference pixel in connection with a shadow, a color, and a size of the pixel and have a predetermined data value allotted to each thereof are substituted for the fragmented reference pixel on a one-to-one basis, thereby inserting desired information data without changing the state of an original file to be encrypted.

### BACKGROUND

In general, due to the development of communication networks such as the Internet, various service passes such as movie or play tickets, bus tickets, aircraft passes, ship passes, dining tickets, and the like can be booked and purchased on-line.

A procedure for this purchase requests a different certification procedure for identification, and identification cards (e.g., a social security card, a passport, a driver's license, a student identification card, an employee identification card, etc.) that are mainly used for the certification procedure are coated with a name, an address, a number, a signature or fingerprint, etc., of a card holder together with a photograph, so as to be able to identify the card holder.

Further, the other procedures and documents required for additional identification are dependent on the service of interest. Hence, the procedure for the identification is very complicated, and thus causes inconvenience to a subscriber or purchaser.

Of course, an example of a representative coding method for such goods or identities includes the bar code. Bar codes have proliferated to world-wide distribution with highly advanced usages. The bar code is commonly printed on labels for foodstuffs, sundry goods, and the like. The bar code is employed to obtain information about the goods, so that the obtained information can be databased and then utilized as distribution and sales data.

Bar codes are classified as primary bar codes or secondary bar codes. The primary bar code, which we generally see in the everyday life, stores a preset, limited degree of information. In the primary bar code, data after being decoded is expressed textually, and the storage capacity thereof is about 20 characters or so. Accordingly, only a small quantity of data can be encoded thereby.

In a primary bar code, almost all articles and goods can be expressed by the combination of 20 characters afforded thereby. However, primary bar codes are not sufficient to express further information about, for instance, the corresponding goods and certification, other articles, and so on.

Secondary bar codes are used to compensate for this drawback. In a secondary bar code, data after being decoded is expressed by alphabets, digits, binary digits, etc. and affords data storage capacity of about 2000 characters or so; and therefore, a very large quantity of data can be expressed by the values encoded in a secondary bar code. Hence, almost all goods can be expressed by combination of 2000 characters, so that the secondary bar code can be applied to certification and other fields.

However, the application fields are gradually increased, and data required for certification increases due to a complicated certification process and diversity of physical distribution. Further, considering that more information about the goods is stored and used as distribution and marketing data, there is a high possibility of the storage capacity of about 2000 characters becoming short in the future.

Further, the primary and second bar codes are not encrypted. If the bar codes are copied and used, it is impossible to check whether the bar codes are copied or counterfeited.

### SUMMARY

Therefore, in view of the above-mentioned problems, a method for encrypting and decrypting data using pixels is presently provided, in which input background information such as characters, digits, figures, lines, pictures, etc., is fragmented into minute pixels as basic units, and pixels that have a characteristic value different from that of a reference pixel in connection with a shadow, a color, and/or a size of the pixel and have a predetermined data value allotted to each thereof are substituted one-to-one for the fragmented reference pixel, thereby inserting desired information data without changing the state of an original file to be encrypted.

Also provided is a method for encrypting and decrypting data using pixels, capable of using background information as text coded by a combination of characters and digits, and using the combination of characters and digits as an address value of a databased group, thereby simplifying processes of encrypting and decrypting the data.

According to one aspect, as a non-limiting example, there is provided a method for encrypting data, which includes a first step of, on the basis of a reference pixel having predetermined characteristic values with respect to a shade, a size, and a color, defining pixels having a different characteristic value with respect to at least one of the shade, size, and color of the reference pixel, allotting a predetermined data value to each of the defined pixels to thereby group the defined pixels, and differently allotting a designated data value to each of the defined pixels to thereby create a plurality of other groups, a second step of designating address values to the plurality of groups respectively, regarding the address values as data, converting the address values into pixels having different characteristic values respectively, and creating the address values converted into the pixels into a group, a third step of storing and databasing the plurality of pixel groups and the address value group at respectively designated locations, a fourth step of receiving background information (various data) into which data to be encrypted is to be inserted, and fragmenting the background information into basic pixel units, a fifth step of calling a randomly selected pixel group having the data value and the pixel group having the address value from a database, a sixth step of converting the address value designated to the selected pixel group into a pixel, receiving information to be encrypted and inserted, comparing the insertion information with the data value of the called pixel group, and converting the insertion information into pixels having values equal to the data value, a seventh step of designating locations on the background information intended to insert the converted pixels, and substituting the converted pixels for the existing reference pixels situated at the designated locations, and an eighth step of combining and outputting the background information that becomes a basic background and is decomposed into a basic element of the pixel and the substituted insertion information.

According to another aspect, as a non-limiting example, there is provided a method for decrypting data using pixels, which includes a first step of allowing background information encrypted and output by way of a combination of substituted insertion information to be received again through an image input device, a second step of fragmenting the re-received background information into basic pixel units, a third step of sequentially reading in the fragmented pixels according to a designated sequence, comparing the fragmented pixels with a reference pixel, and extracting at least one pixel inconsistent with the reference pixel, a fourth step of calling an address value group, comparing and analyzing a pixel of the address value group and the extracted pixel, and retrieving an address value of the pixel group used, a fifth step of calling a corresponding group of pixels storing the address value as an address from a database, a sixth step of, after the pixel having the address value is excluded, sequentially comparing the extracted pixels with the pixels of the pixel group called from the database, and converting the extracted pixels into data values which the pixels have.

Accordingly, because the reference pixels and the non-reference pixels are one-to-one substituted at the same locations of the fragmented pixels, it is difficult to see and discriminate or read the state change of an original file before and after encryption, and thus the laypeople cannot know where information is inserted and whether or not the background information is encrypted. Hence, when the present method is applied to prints, such as trademarks of goods, logos, bills, marketable securities, and so on, composed of a plurality of pixels, each print is coded without changing an image in whole or in part, so that counterfeiting or forgery can be firmly prevented. The data is carried on the trademark or logo made of the encrypted pixels, the trademark or logo itself can be used like a bar code.

Further, the present method utilizes a shade, a size, and/or a color as characteristic values, so that it is not limited as to the number of representable data.

### BRIEF DESCRIPTION OF THE DRAWINGS

The foregoing and other objects, features and advantages will become more apparent from the following detailed description when taken in conjunction with the accompanying drawings, in which:

FIG. 1 is a flow chart illustrating a method for encrypting data;

FIG. 2 is a flow chart illustrating a method for decrypting data;

FIG. 3 is a flow chart illustrating a method for encrypting data in accordance with a first embodiment;

FIG. 4 is a flow chart illustrating a method for decrypting data in accordance with a first embodiment;

FIG. 5 illustrates a configuration of a system according to a second embodiment;

FIG. 6 is a flow chart illustrating a method for encrypting and decrypting data according to the second embodiment; and

FIG. 7 illustrates a state of fragmenting encrypted background information into pixel units in accordance with a second embodiment.

### DETAILED DESCRIPTION

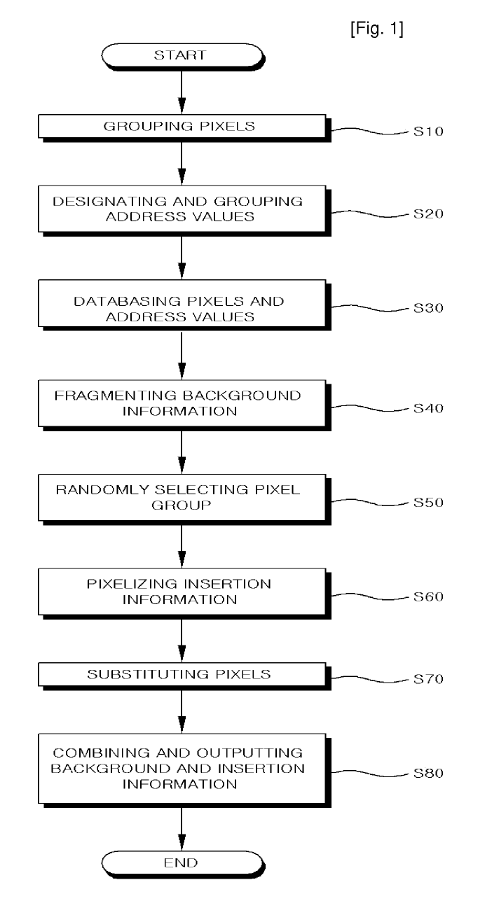

Reference will now be made in detail to example embodiments of the present discussion. FIG. 1 is a flow chart illustrating a method for encrypting data, such as, for example, to encrypt information inserted into various prints in order to prevent the prints from being counterfeited or forged, and/or to decrypt the inserted information. For the purpose of encryption and decryption, a pixel is used as a basic unit constituting data. The prints counterfeited or forged can include various on-line media (e.g., electronic identification cards, electronic cards, electronic business cards, electronic cash, etc.) and various off-line media (e.g., business cards, bills, marketable securities, identification cards, civil affair documents, passports, credit cards, certificates, etc.).

The process of encrypting data using pixels is generally divided into a preprocessing process and an encrypting process. Referring to FIG. 1, the pre-processing process includes a step S10 of grouping pixels, a step S20 of designating and grouping address values, and a step S30 of databasing the pixels and address values.

Generally observing printed image or text with a microscope, it can be found that the image or text is composed of many points at regular intervals, and that a contour or shade of the image or text is expressed according to a size of the point. Each of the points is called a pixel, which is the smallest unit constituting the image or text for the off-line media (e.g., marketable securities, identification cards, photographs, etc.) and the on-line media (e.g., all images displayed on a screen of a mobile phone's liquid crystal display, a monitor, or a digital camera, etc.).

In step S10 of grouping pixels, a reference pixel having constant characteristic values with respect to shade, size, and color values is defined, and then non-reference pixels having a different characteristic value with respect to at least one of the shade, size, and color values of the reference pixel are defined. A predetermined data value is allotted to each of the defined non-reference pixels. Thereby, the pixels are converted into a group.

More specifically, the shade used for comparing the reference pixel with the non-reference pixels indicates how dark or light a color is, and thus it can be subdivided and represented into a plurality of levels on the basis of the degree of lightness which a given color has, like luminosity.

Further, the color is represented by a combination of three primary colors, and it can be generally subdivided into 256 colors. Hence, the color makes it possible to encrypt a huge quantity of data together with the shade and size.

The data value gives a generic name to each of the consonants and vowels constituting Hangul, each alphabet of upper-case and lower-case letters indicating English, each character by countries, a binary digit, a character and symbol recognized by the eye, and the like. The data is limited to number, which is included in the number of cases of the non-reference pixels having different characteristic values in terms of the reference pixel.

Further, the data can be allotted to the pixel with a data value in a state where one or more constituents, for instance “Tom” or “John” are combined.

Then, in step S10 of grouping pixels, the designated data value is differently allotted to each of the non-reference pixels, thereby creating other groups of pixels. In this way, a plurality of groups is created.

In step S20 of designating and grouping address values, the address values are designated to the created plurality of groups of pixels, respectively. The address values are regarded as data, and then converted into non-reference pixels having different characteristic values, respectively. The address values converted into the pixels are created into a group.

In step S30 of databasing the pixels and address values, as described above, the plurality of created pixel groups and the created address value group are stored in respectively designated database locations.

More specifically, the address value group serves as a security key. Because the address values are created into one group, the address value group has a designated address value. In the following decryption, when the address value of the pixel group used is retrieved, the address value group is directly called and used to analyze the pixel. This process can be controlled by a program.

The encrypting process includes a step S40 of fragmenting background information, a step S50 of randomly selecting a pixel group, a step S60 of pixelizing insertion information, a step S70 of substituting pixels, and a step S80 of combining and outputting the background and insertion information.

In step S40 of fragmenting background information, the background information (various data) into which data to be encrypted is inserted is received, and then fragmented into basic pixel units.

Then, in step S50 of randomly selecting a pixel group, in order to encrypt information to be inserted, the randomly selected pixel group and another pixel group having the address value are called from stored database addresses.

In step S60 of pixelizing insertion information, the address value designated to the selected pixel group is converted into a pixel having the address value using the address value group called in step S50. Information to be encrypted and inserted is received, and the insertion information is compared with the data value of the pixel group that is randomly selected and called from the database. As a result, the insertion information is converted into pixels having values equal to the data value.

In step S70 of substituting pixels, in the fragmented background information, locations on the background information intended to insert the insertion information converted into the pixels are designated, and the existing reference pixels situated at the designated locations are substituted with the converted pixels.

When it comes to the location intended to insert the insertion information, because the present approach makes use of the pixel, the smallest unit of the data, and allots the data to each pixel, any place such as a character, a picture, a line, etc. will do if the pixel is present.

In addition, when the reference pixel is substituted by the converted pixel, preferably, the pixel having an address value is located first, and then the pixel having a value of the information to be inserted is located.

Finally, in step S80 of combining and outputting the background and insertion information, the background information that becomes a basic background and is decomposed into a basic element of the pixel and the substituted insertion information are combined, encrypted, and output.

In the background information, such as graphic or text, output by way of the encrypting process, the pixels are not added or changed in position, but they are subjected to one-to-one substitution so as to correspond to each other at the same location. As such, it is difficulty to discriminate a state change of an original file before and after being encrypted.

Therefore, because the public cannot know where the insertion information is inserted or whether or not the background information is encrypted, the present approach allows a trademark or logo where the pixel is encrypted to be used like the bar code. Simultaneously, the present approach can firmly prevent forgery of the trademark or logo, thereby improving reliability of goods.

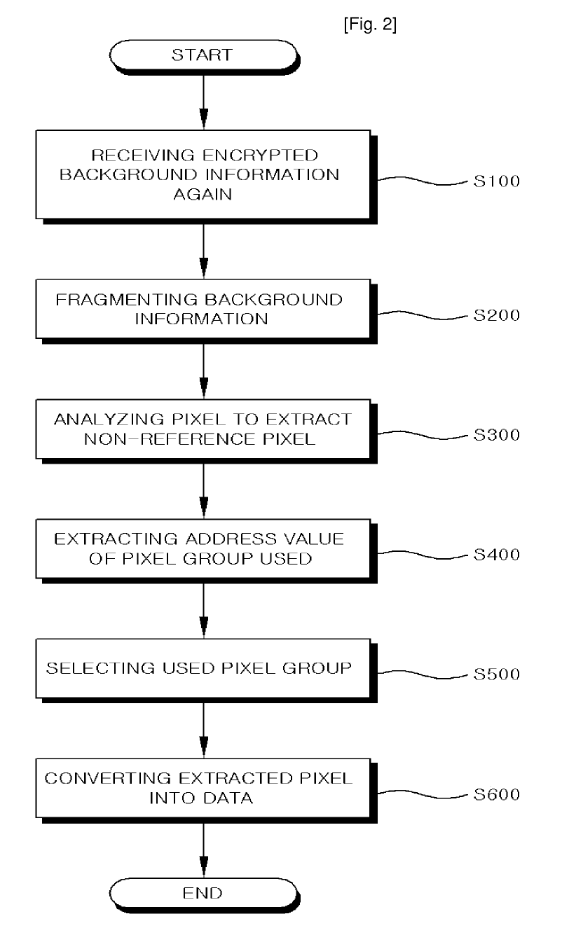

FIG. 2 is a flow chart illustrating a method for decrypting data in accordance with the present approach. Referring to FIG. 2, for example, it can be seen how data inserted into the background information—such as graphics or text undergoing the encrypting process—is decrypted.

The method for decrypting data using pixels is generally divided into a process of pre-processing the encrypted background information, and a decrypting process.

The pre-processing process of the encrypted background information includes a step S100 of receiving encrypted background information again, and a step S200 of fragmenting the background information.

In step S100 of receiving encrypted background information again, the background information output by way of the encrypting process is received again through an image input device such as a digital camera (including a terminal equipped with the digital camera), a scanner, a Point-Of-Sale (POS) System, or the like.

Next, in step S200 of fragmenting the background information, the re-received background information is fragmented into basic pixel units.

The layman can see about 150 levels of grey scale between black and white. In the digital processing, various levels of grey scale of 2, 4, 8, 16, 32, 64, 128, 256, and so on are employed. Among them, the 128 level is visible to ordinary sight, and thus the 256 level is employed.

Therefore, either a digital camera or a terminal equipped with such a digital camera can be used as the image input device in the decryption process.

The decrypting process includes a step S300 of analyzing the pixel to extract a non-reference pixel, a step S400 of extracting the address value of a pixel group used, a step S500 of selecting the used pixel group, and a step S600 of converting the extracted pixel into data.

First, in step S300 of analyzing the pixel to extract a non-reference pixel, the pixels of the background information re-received and fragmented into pixel units are sequentially read in according to a designated sequence, and compared with the reference pixel with respect to characteristic values of shade, size, and color. As a result, the non-reference pixel inconsistent with the reference pixel is extracted.

Then, in step S400 of extracting the address value of a pixel group used, first, an address value group is called from a database, and a pixel of the called address value group and the extracted non-reference pixel are analyzed. A pixel having the address value of the used pixel group is retrieved, and thereby the address value is retrieved.

In step S500 of selecting the used pixel group, a corresponding pixel group stored in the database is called by adopting the address value extracted in step S40 as an address.

Finally, in step S600 of converting the extracted pixel into data, after the pixel having the address value is excluded from the extracted pixels, the extracted pixels are sequentially compared with the pixels of the pixel group called from the database, and converted into data values which the pixels have. Thereby, the background information is decrypted and output.

The methods for encrypting and decrypting data using pixels, as described above, in accordance with the present approach can be implemented as an issuing device employing forgery-free technology and a decryption device capable of certifying identification of a user, and applied to various fields.

In the encrypting and decrypting processes, the background information is used as text coded by a combination of characters and digits consisting of a plurality of pixels, and data which the plurality of pixels constituting the combined characters and digits has are converted into a group. The address on the database in which the group stored makes use of the combination of characters and digits constituting the background information. As a result, the methods for encrypting and decrypting data can be simplified.

### EMBODIMENT 1

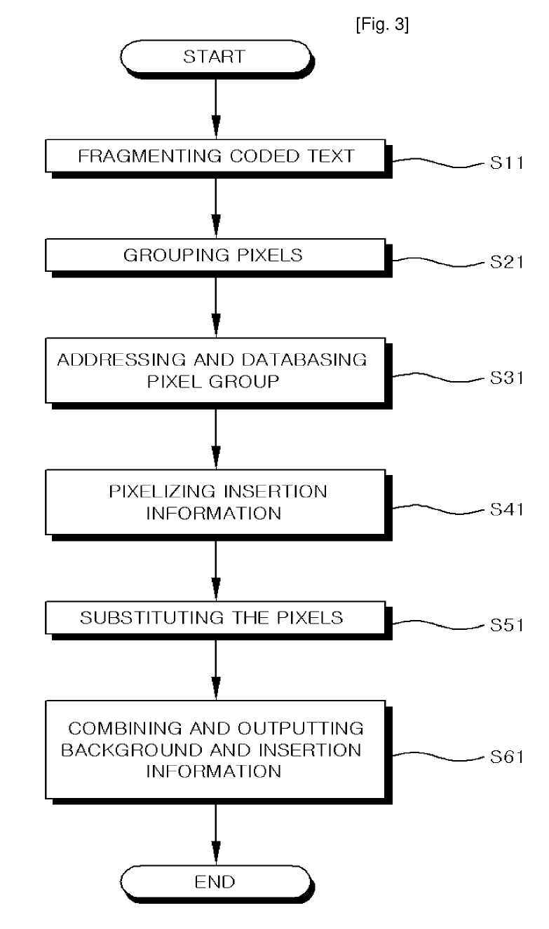

FIG. 3 is a flow chart illustrating a method for encrypting data in accordance with a first non-limiting example embodiment. The method for encrypting data is generally divided into a pre-processing process and an encrypting process, as in the present discussion. Referring to FIG. 3, the pre-processing process includes a step S11 of fragmenting coded text, a step S21 of grouping pixels, and a step S31 of addressing and databasing the pixel group.

First, in step S11 of fragmenting coded text, the text primarily coded by a combination of characters and digits is received, and fragmented into basic pixel units. Then, in step S21 of grouping pixels, on the basis of a reference pixel having constant characteristic values with respect to a shade, a size, and a color, and then pixels having a different characteristic value with respect to at least one of the shade, size, and color of the reference pixel are defined. A predetermined data value is allotted to each of the defined pixels. Thereby, the pixels are converted into a group.

In the last step of the pre-processing process, i.e. in step S31 of addressing and databasing the pixel group, the pixel group is stored in a database using the characters and digits constituting the coded text as an address value.

For example, the coded text corresponds to the background information of the present approach, and is obtained by the combination of characters and digits, and can be composed of text such as 2a5b, 1234, or abed, as non-limiting examples.

In this embodiment, because the text such as 2a5b, 1234, or abed is used as the address value, a step of pixelizing a separate address value group in order to databasing the pixel group, and storing the pixelized address value group in step S20 of designating and grouping address values is omitted. Therefore, the encrypting process is simplified.

The encrypting process includes a step S41 of pixelizing insertion information, a step S51 of substituting the pixels, and a step S61 of combining and outputting the background and insertion information.

In step S41 of pixelizing insertion information, information (data) to be inserted into the coded text is received. Then, the insertion information is compared with the data values which the grouped pixels have, and converted into pixels having values equal to the data values.

In step S51 of substituting the pixels, locations on the coded text intended to insert the converted pixels are designated, and the existing reference pixels at the designated locations are substituted by the converted pixels.

In the last step of the encrypting process, i.e. in step S61 of combining and outputting the background and insertion information, the text that becomes a basic background and is decomposed into a basic element of the pixel and the substituted insertion information are combined, encrypted, and output.

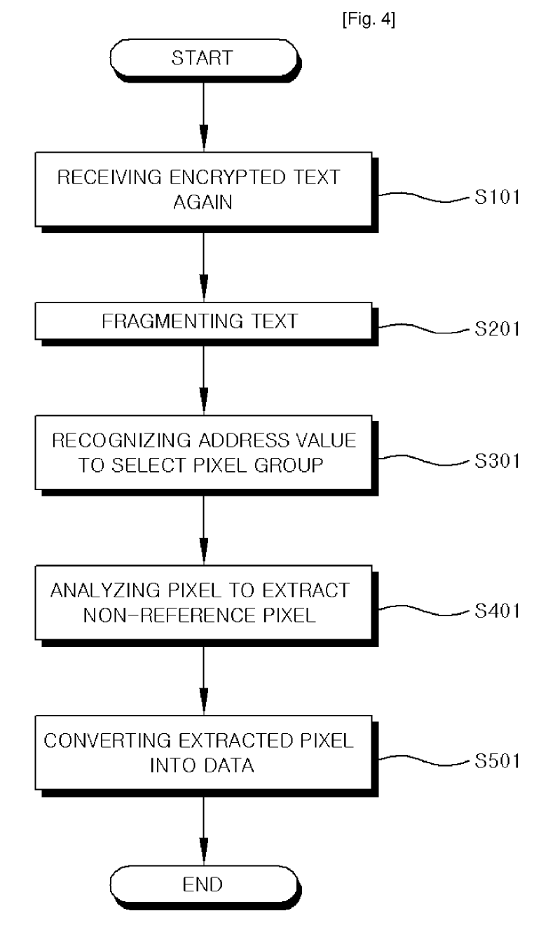

FIG. 4 is a flow chart illustrating a method for decrypting data in accordance with the first embodiment.

Referring to FIG. 4, it can be seen how data inserted into the coded text going through the encrypting process according to the first embodiment is decrypted.

The method for decrypting the text encrypted according to the first embodiment is generally divided into a process of pre-processing the coded text, and a decrypting process.

The pre-processing process of the coded text includes a step S101 of receiving encrypted text again, and a step S201 of fragmenting the text.

In step S101 of receiving encrypted text again, the text encrypted and output through a combination with the substituted insertion information is received again through an image input device such as a digital camera (including a terminal equipped with the digital camera), a scanner, a POS System, or the like.

Next, in step S201 of fragmenting the text, the re-received text is fragmented into basic pixel units.

The decrypting process includes a step S301 of recognizing an address value to select a pixel group, a step S401 of analyzing the pixel to extract a non-reference pixel, and a step S501 of converting the extracted pixel into data.

First, in step S301 of recognizing an address value to select a pixel group, because the combination of characters and digits constituting the coded text is recognized as the address value and stored in the database in the encrypting process, the address value is extracted by reading the text, and the pixel group stored at a location having the address value is called from the database.

Hence, in the data decrypting process of the present example, the processes of sequentially reading in the fragmented pixels, separately calling the address value group stored in the database, and comparing and analyzing the fragmented pixels and the pixels stored in the address value group are omitted.

In step S401 of analyzing the pixel to extract a non-reference pixel, the pixels of the text re-received and fragmented into pixel units are sequentially read in according to a designated sequence. The fragmented pixels are compared with the reference pixel, and thereby the non-reference pixel inconsistent with the reference pixel is extracted.

Finally, in step S501 of converting the extracted pixel into data, the non-reference pixel is sequentially compared with the pixels of the corresponding pixel group called from the database, and the information inserted into the text encrypted by conversion into data values which the pixels have is decrypted and output.

### EMBODIMENT 2

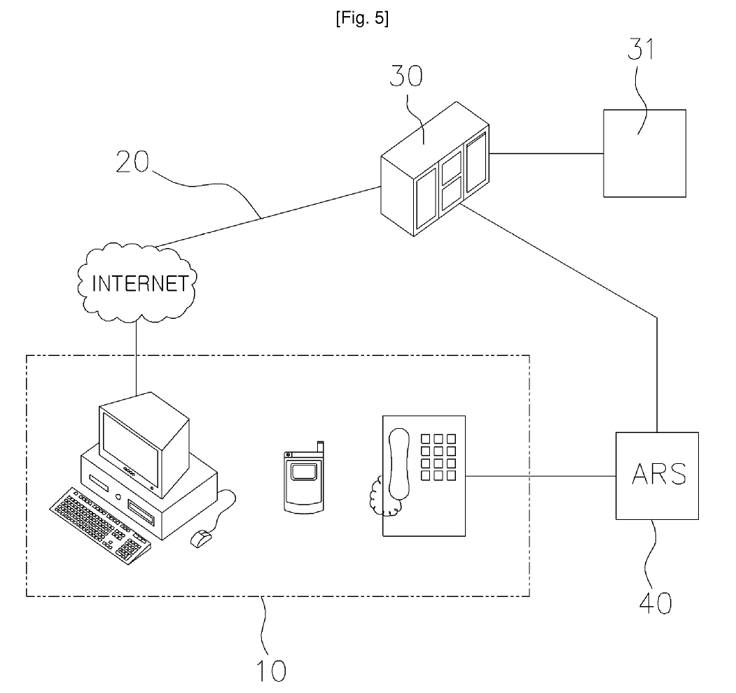

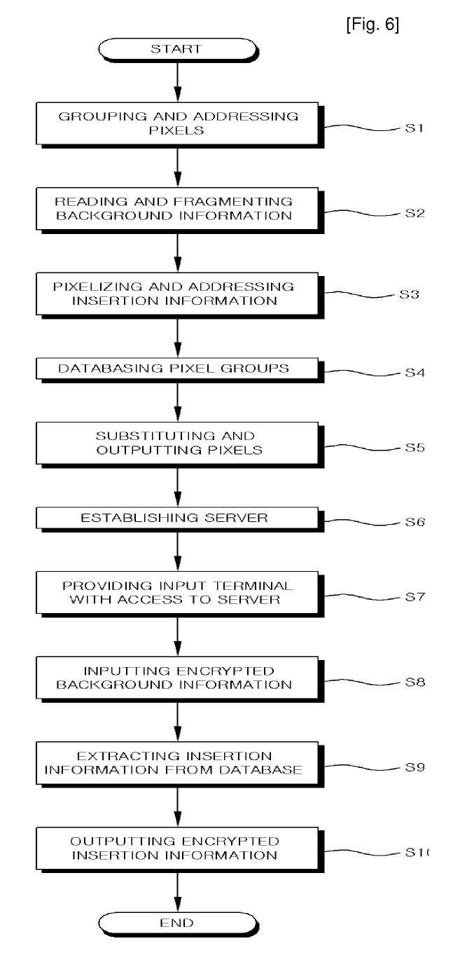

FIG. 5 illustrates a configuration of a system according to a second non-limiting example embodiment, and FIG. 6 is a flow chart illustrating a method for encrypting and decrypting data according to the second embodiment. The method for encrypting and decrypting data according to the second embodiment will be described by dividing into an encrypting process and a decrypting process.

The encrypting process includes a step S1 of grouping and addressing pixels, a step S2 of reading and fragmenting background information, a step S3 of pixelizing and addressing insertion information, a step S4 of databasing pixel groups, and a step S5 of substituting and outputting the pixels. First, in step S1 of grouping and addressing pixels on the basis of a reference pixel having constant characteristic values with respect to a shade, a size, and a color, pixels having a different characteristic value with respect to at least one of the shade, size, and color of the reference pixel are defined as in the above-described processes. A predetermined data value is allotted to each of the defined pixels. Thereby, the defined pixels become a group, and are addressed.

Then, in step S2 of reading and fragmenting background information, the background information that is composed of a combination of characters and digits and is to be encrypted is read in, and fragmented into basic pixel units.

In step S2, the background information is read, and thereby the combination of characters and digits constituting the background information is stored. This is directed to use the characters and digits as an address value for storing insertion information to be described below.

Subsequently, in step S3 of pixelizing and addressing insertion information, a data value of information to be inserted is compared with data values which the grouped pixels have, and the insertion information is converted into pixels. The converted pixels are grouped by using the combination of characters and digits constituting the background information as the address value.

In step S4 of databasing pixel groups, the groups of pixels created in each step are stored at designated addresses, and databased.

In the last step of the encrypting process, i.e. in step S5 of substituting and outputting the pixels, locations on the background information intended to insert the insertion information converted into the pixels are designated, and the existing reference pixels situated at the designated locations are substituted by the converted pixels. The background information and the substituted insertion information are combined and output.

The process of decrypting the data encrypted through steps S10 through S50 includes a step S6 of establishing a server, a step S7 of providing an input terminal with access to the server, a step S8 of inputting encrypted background information, a step S9 of extracting insertion information from a database, and a step S10 of outputting encrypted insertion information.

In step S6 of establishing a server, the communication service server 30 is established using the database created in step S4 of the encrypting process.

Then, in step S7 of providing an input terminal with access to the server, the input terminal 10 provides a service so as to be able to provide access to the communication service server. The input terminal 10 includes a mobile phone or computer using the Internet 20, and an automatic response service (ARS) system 40 using wired communication.

In step S8 of inputting encrypted background information, the encrypted background information is input using the ARS system using wired communication, the mobile phone using the Internet, and operating keys, such as numeral buttons and keys of a keyboard, of the computer using the Internet.

Subsequently, in step S9 of extracting insertion information from a database, the input information is recognized as an address value, and a pixel group stored at a location having the address value is called from the database.

Finally, in step S10 of outputting encrypted insertion information, the corresponding group of pixels called from the database are sequentially compared with the group of pixels created in step S1 of the encrypting process, and converted into data values which the pixels have. The converted data values are output.

A state where the background information used in the second embodiment is encrypted by use of the pixels will be described with reference to the attached figure.

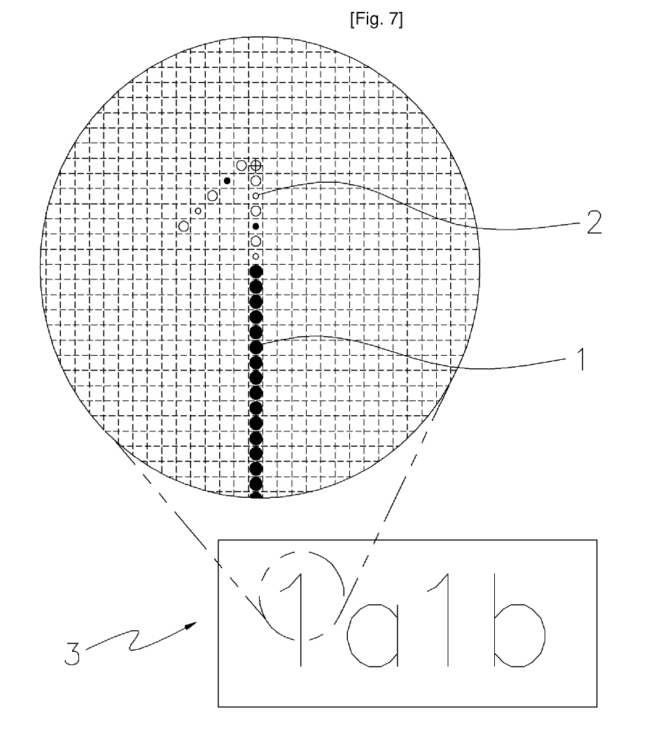

FIG. 7 illustrates a state of fragmenting encrypted background information into pixel units in accordance with the second embodiment, in which the encircled region magnifies some of the pixels constituting the background information.

The background information 3 is formed by a combination of characters, digits, and the like. Hence, the coded background information 3 can be used by application to a bar code concept.

More specifically, in the background information 3, a bar code where the characters and/or digits are combined by a symbol consisting of black and white strips is substituted by a bar code having a combination of characters and/or digits rather than the strip-like symbol. The encrypted information is inserted into the background information 3, and a value representing the background information 3 itself is allowed to be used as an address value or a certification value.

Referring to FIG. 7, the combination of characters and/or digits constituting the background information 3 is “1a1b.” Here, it can be seen that a plurality of pixels constituting the combination “1a1b” is combined by reference pixels 1 and non-reference pixels 2.

Data of the insertion information to be inserted is carried on each of the non-reference pixels 2. The non-reference pixels 2 having the data of the insertion information are stored at a “1a1b” location on the database by using the “1a1b” constituting the background information 3 as the address value.

Accordingly, when the encrypted background information 3 is input through the input terminal 10 again, the background information 3 is read, and values of the non-reference pixels 2 stored in the read “1a1b” are called from the database. Then, the insertion information is decrypted and output.

The present approach may be constructed to provide access to a related enterprise server or a related service server supporting the bar code substituted based on the above-mentioned idea through wired/wireless communication (inputting characters and/or digits according to an ARS instruction) or Internet, and input the combined characters and/or digits of the issued bar code, or obtain information such as a service list inserted into the background information through retrieval with or without log-in.

To this end, the present approach may include a step of separately databasing the information of the bar code by using the combined characters and/or digits constituting the bar code as the address value, and checking the information one or more times.

Alternatively, in order to receive the information of the substituted bar code that is combined by characters and/or digits in accordance with the second (and/or further) embodiment, the present approach may include a step of providing access to a related enterprise server or a related service server supporting the bar code substituted based on the above-mentioned idea through wired/wireless communication (inputting characters and/or digits according to an ARS instruction) or Internet, a step of providing a service list after or regardless of log-in, a step of inputting the combined characters and/or digits constituting the substituted bar code in order to check information of the substituted bar code using the service list, and requesting retrieval and certification (validation), and a step of retrieving the combined characters and/or digits constituting the substituted bar code requested for the certification (certification validation whether it is true or not) by an arbitrary mobile phone or computer, and informing the retrieved result by voice or text.

While the present discussion has been described in connection with what is presently considered to be the most practical and preferred embodiment, it is to be understood that the present invention is not limited to the disclosed example embodiments or to the drawings, but, on the contrary, encompasses various modifications and variations within the spirit and scope of the appended claims.

1. A method for encrypting data, comprising:
defining, on the basis of a reference pixel having predetermined characteristic values with respect to a shade, a size, or a color, one or more pixels having a different characteristic value with respect to at least one of the shade, size, or color of the reference pixel, allotting a predetermined data value to each of the defined pixels to thereby group the defined pixels, and differently allotting a designated data value to each of the defined pixels to thereby create a plurality of other groups;
designating address values to the plurality of groups respectively, regarding the address values as data, converting the address values into pixels having different characteristic values respectively, and creating the address values converted into the pixels into a group;
storing and databasing the plurality of pixel groups and the address value group at respectively designated locations;
receiving background information into which data to be encrypted is to be inserted, and fragmenting the background information into basic pixel units;
calling a randomly selected pixel group having the data value and the pixel group having the address value from a database;
converting the address value designated to the selected pixel group into a pixel, receiving information to be encrypted and inserted, comparing the insertion information with the data value of the called pixel group, and converting the insertion information into pixels having values equal to the data value;
designating one or more locations on the background information intended to insert the converted pixels, and substituting the existing reference pixels situated at the designated locations with the converted pixels; and
combining and outputting the background information that becomes a basic background and is decomposed into a basic element of the pixel and the substituted insertion information.

2. A method for decrypting data using pixels, comprising:
allowing background information encrypted and output by way of a combination of substituted insertion information to be received again through an image input device;
fragmenting the re-received background information into basic pixel units;
sequentially reading in the fragmented pixels according to a designated sequence, comparing the fragmented pixels with a reference pixel, and extracting at least one pixel inconsistent with the reference pixel;
calling an address value group, comparing and analyzing a pixel of the address value group and the extracted pixel, and retrieving an address value of the pixel group used;
calling a corresponding group of pixels storing the address value as an address from a database;
sequentially comparing the extracted pixels with the pixels of the pixel group called from the database after the pixel having the address value is excluded, and converting the extracted pixels into data values which the pixels have.

3. A method for encrypting data, comprising:
receiving text coded by a combination of characters and digits, and fragmenting the text into basic pixel units;
defining, on the basis of a reference pixel having predetermined characteristic values with respect to a shade, a size, or a color, one or more pixels having a different characteristic value with respect to at least one of the shade, size, or color of the reference pixel, and allotting a predetermined data value to each of the defined pixels to thereby group the defined pixels;
databasing the pixel group so as to be stored using the characters and digits constituting the coded text as an address value;
receiving information to be inserted into the coded text, comparing the insertion information with the data values of the grouped pixels, and converting the insertion information into pixels having values equal to the data values;
designating one or more locations on the coded text intended for insertion of the converted pixels, and substituting the existing reference pixels at the designated locations with the converted pixels; and
combining and outputting the text that becomes a basic background and is decomposed into a basic element of the pixel and the substituted insertion information.

4. A method for decrypting data using pixels, comprising:
allowing text encrypted and output by way of a combination of substituted insertion information to be received again through an image input device;
fragmenting the re-received text into basic pixel units;
recognizing characters and digits constituting the text as an address value, and calling a pixel group stored at a location having the address from a database;
sequentially reading in the fragmented pixels according to a designated sequence, comparing the fragmented pixels with a reference pixel, and extracting at least one non-reference pixel inconsistent with the reference pixel; and
sequentially comparing the non-reference pixel with a corresponding group of pixels called from the database, and converting the non-reference pixel into a data value of the pixel.

5. A method for encrypting and decrypting data, comprising:
defining, on the basis of a reference pixel having constant characteristic values with respect to a shade, a size, or a color, one or more pixels having a different characteristic value with respect to at least one of the shade, size, or color of the reference pixel, allotting a predetermined data value to each of the defined pixels to thereby group the defined pixels, and designating an address to each of the defined pixels;
reading in background information to be encrypted, including a combination of characters and/or digits, and fragmenting the background information into basic pixel units;
comparing a data value of information to be inserted with data values of the grouped pixels, converting the insertion information into pixels, and grouping the converted pixels by using a combination of characters and/or digits constituting the background information as an address value;
storing each of the created groups of pixels at designated addresses, and databasing the groups of pixels in a database;
designating locations on the background information intended for insertion of the insertion information converted into the pixels, substituting existing reference pixels situated at the designated locations with the converted pixels, and combining and outputting the background information and the substituted insertion information;
establishing a communication service server using the database of the groups of pixels;
allowing at least one of an automatic response service (ARS) system using wired communication, a mobile phone or a computer using the Internet to provide access to the communication service server;
inputting encrypted background information using any of the ARS system, the mobile phone, or the computer;
recognizing the input information as the address value, and calling the pixel group stored at a location having the address value from the database; and
sequentially comparing the corresponding group of pixels called from the database with the pixels defined on the basis of the reference pixel, converting the called pixels into data values of the pixels, and outputting the converted data values.
